(19) United States
(12) Patent Application Publication
(10) Pub. No.: US 2017/0308234 A1
(43) Pub. Date: Oct. 26, 2017

(54) MOBILE TERMINAL

(71) Applicant: SHENZHEN GOODIX TECHNOLOGY CO., LTD., Shenzhen (CN)

(72) Inventors: Ke LI, Shenzhen (CN); Bo PI, Shenzhen (CN)

(73) Assignee: SHENZHEN GOODIX TECHNOLOGY CO., LTD., Shenzhen (CN)

(21) Appl. No.: 15/647,498

(22) Filed: Jul. 12, 2017

Related U.S. Application Data
(63) Continuation of application No. PCT/CN2016/105000, filed on Nov. 8, 2016.

(30) Foreign Application Priority Data
Dec. 24, 2015 (CN) 201521100005.8

(51) Int. Cl. G06F 3/041; G06F 1/16; H04M 1/02

(52) U.S. Cl. CPC G06F 3/0416; H04M 1/026; G06F 1/1694; H04M 2250/22

(57) ABSTRACT

An electronic device, specifically, a mobile terminal, includes a sensing identification module. The sensing identification module is arranged within a casing of the mobile terminal, and an area of an outer surface of the casing corresponding to the sensing identification module serves as a touch area, and at least part of the touch area is concave or convex.

### CROSS-REFERENCE TO RELATED APPLICATIONS

The present application is a continuation of International Application No. PCT/CN2016/105000, filed on Nov. 8, 2016, which claims the priority to Chinese Patent Application No. 201521100005.8, filed with the Chinese Patent Office on Dec. 24, 2015, both of which are incorporated herein by reference in their entireties.

### TECHNICAL FIELD

The present invention relates to an electronic device and specifically, to a mobile terminal.

### BACKGROUND

With the rapid development of science and technology, terminal devices, such as a cell phone or a tablet computer and the like, becomes more popular, as the terminal devices could not only be used to send and receive massages and make phone calls, but could also be used to surf the Internet, send and receive e-mails, listen to the music and play games, etc. The terminal devices are now developed from original key-pressing devices to touching devices.

Most of the present sensing identification modules are capacitive sensing identification modules of a pressing-type, the sensing identification module is exposed by drilling a hole on a glass cover plate, a metal casing or a plastic casing, so as to be contacted by a finger. However, such drilling process not only increases the fabrication difficulty, but also brings the difference in visual and tactile senses due to separate assembly of the sensing identification module, and thus the structure and appearance of the whole device as well as the user's experience are affected.

Therefore, a problem to be solved at present is how to lower the fabrication difficulty of whole device and reduce the difference between the sensing identification module and the casing while guaranteeing the normal use of the sensing identification module, and thus improving the appearance of the whole device and enhancing the user experience.

### SUMMARY

The purpose of some embodiments of the present invention is to provide a mobile terminal which is capable of reducing difference between the sensing identification module and the casing while the user performs a press and touch operation on an outer surface of the casing, and thus improving the appearance of the whole device and the user's experience.

To solve the technical problems mentioned above, some embodiments of the present invention provide a mobile terminal, which includes a sensing identification module, the sensing identification module is arranged within a casing of the mobile terminal, an area of an outer surface of the casing corresponding to the sensing identification module serves as a touch area, and at least part of the touch area is concave or convex.

As compared with the prior art, the sensing identification module according to the present invention is arranged inside of the casing of the mobile terminal, and the area of the outer surface of the casing corresponding to the sensing identification module serves as the touch area, so that the sensing identification module may not be exposed to the outside circumstance of the casing; and at least part of the outer surface of the casing corresponding to the touch area is concave or convex; with this configuration, when using the mobile module, a user may quickly find out the location of the touch area on the outer surface of the casing by means of only tactile sense of the finger, which reduces the difference in visual sense and tactile sense that might otherwise exist due to separate assembly of the sensing identification module while the user performs a press and touch operation on the outer surface of the casing, and thus improves the appearance of the whole device and enhances the user's experience. In addition, since no drilling process for forming a hole on the casing to accommodate the sensing identification module is needed, the fabricating procedures of the whole device are reduced and thus the fabricating difficulty is lowered.

In some embodiments, the touch area on the casing as a whole is a first concavity, or the touch area on the casing as a whole is a convexity. By means of fabricating the touch area as a concavity or convexity, the accuracy for the user's finger pressing the touch area located on the outer surface of the casing is increased, and thus the user's experience is enhanced.

Moreover, in order to meet various use habits of different users, when the touch area on the casing as a whole is a first concavity, the first concavity is a concave plane or a concave arc surface; when the touch area on the casing as a whole is a convexity, the convexity is a convex plane or a convex arc surface.

In some embodiments, the touch area has a concave or convex annular structure at a periphery thereof, and the annular structure is an annular protrusion structure or an annular groove structure. By means of these annular structures, the accuracy for the user's finger pressing or touching the touch area on the outer surface of the casing is increased, and thus the user's experience is improved.

In addition, the annular structure is a continuous annular structure or an annular structure with breakpoint, so as to meet various use habits of different users. Moreover, to satisfy with design requirements of different mobile terminals, the annular structure may have a square shape, a circular shape or an oval shape.

In some embodiments, the inner side of the casing corresponding to the touch area includes a second concavity, the sensing identification module is arranged within the second concavity. Thus, the casing thickness of the area where the sensing identification module is arranged is effectively reduced, and the signal strength between the touch area and the sensing identification module when the user is pressing or touching the touch area, is strengthened, therefore the data collection of the sensing identification module is further facilitated, and the user's experience is improved. In addition, in order to satisfy with the actual requirement for assembly and design, the second concavity is concave plane or concave arc surface.

Moreover, the touch area is located at a bottom, a front or a side of the casing. The casing is a plastic housing.

### BRIEF DESCRIPTION OF THE DRAWINGS

FIG. 1 is a structure diagram of a mobile terminal according to the first embodiment of the present application;

FIG. 2 is a structure diagram of the first embodiment of the present application in which the annular structure is an annular projection structure;

FIG. 3 is a structure diagram of the first embodiment of the present application in which the annular structure is an annular groove structure;

FIG. 4 is a structure diagram of the first embodiment of the present application in which the annular structure is square;

FIG. 5 is a structure diagram of the first embodiment of the present application in which the annular structure is circular;

FIG. 6 is a structure diagram of the first embodiment of the present application in which the annular structure is oval;

FIG. 7 is a structure diagram of the second embodiment of the present application in which the touch area is a concave plane surface;

FIG. 8 is a structure diagram of the second embodiment of the present application in which the touch area is a concave arc surface;

FIG. 9 is a structure diagram of the second embodiment of the present application in which the touch area is a convex plane surface;

FIG. 10 is a structure diagram of a second embodiment of the present application in which the touch area is a convex arc surface;

FIG. 11 and FIG. 13 are structure diagrams of a third embodiment of the present application in which a side of the casing of the mobile terminal fitted with the sensing identification module, is a concave plane.

FIG. 12 and FIG. 14 are structure diagrams of a third embodiment of the present application in which a side of the casing of the mobile terminal fitted with the sensing identification module is a concave arc surface.

### DETAILED DESCRIPTION

In order to make the objects, technical solutions and advantages of the present invention clearer, some of embodiments of the present invention will be further described in details hereinafter with reference to the drawings. However it should be understood by person skilled in the art that in some embodiments of this patent application, plenty of technical details are described to make this application easier to be understood. However, the technical solutions sought to be protected by the claims of this patent application may be implemented even without the technical details and the changes and modification made based on some of embodiments below.

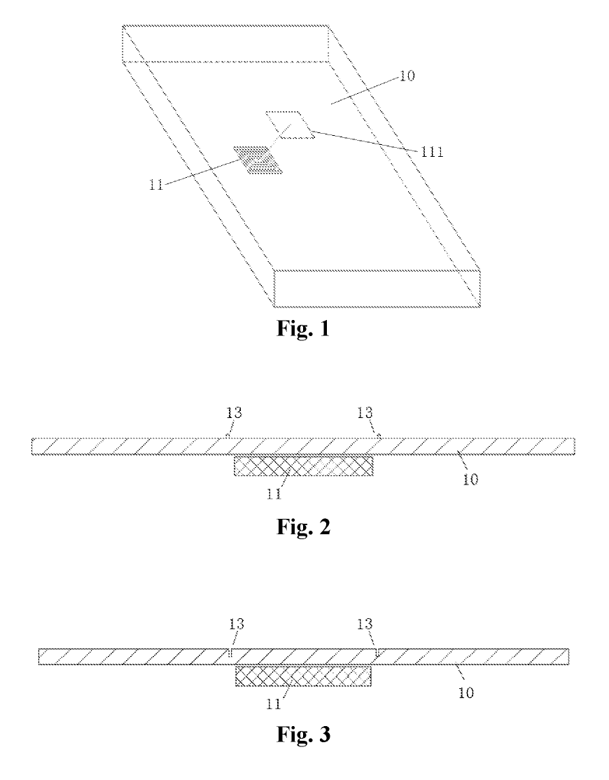

The first embodiment of the present application relates to a mobile terminal, as shown in the FIG. 1 and FIG. 2, the mobile terminal includes a sensing identification module 11. The sensing identification module 11 is arranged within a casing 10 of the mobile terminal. An area of an outer surface of the casing 10 corresponding to the sensing identification module 11 serves as a touch area 111, and at least part of the touch area 111 is concave or convex.

According to the contents mentioned above, it is easy to find out that the sensing identification module 11 is arranged inside of the casing 10 of the mobile terminal, and the area of the outer surface of the casing 10 corresponding to the sensing identification module 11 serves as a touch area 111, so that the sensing identification module 11 may not be exposed to an outside circumstance of the casing 10. Moreover, at least part of the outer surface of the casing 10 corresponding to the touch area 111 is concave or convex; with this configuration, when using the mobile module, a user may quickly find out a location of the touch area 111 on the outer surface of the casing by means of only tactile sense of the finger, which may reduce the difference in visual sense and tactile sense that might otherwise exist due to separate assembly of the sensing identification module 11 while the user performs a press and touch operation on the outer surface of the casing 10, and thus improves the appearance of the whole device and enhances the user's experience. In addition, since no drilling process for forming a hole on the casing to accommodate the sensing identification module is needed, the fabricating procedure of the whole device is reduced and thus the fabricating difficulty is lowered.

In details, in this embodiment, the touch area 111 is actually a sensing projection area, and the sensing projection area may be configured to project information such as a fingerprint, a palm print, a palm vein and the like of the user to the sensing identification module 11 according to a type of the sensing identification module 11. For example, in an embodiment, the sensing identification module 11 may be a fingerprint identification module for detecting fingerprints of a user's finger, and when the touch area 111 is touched or pressed by the user's finger, the sensing projection area may be configured to project the fingerprint information of the user to the sensing identification module 11. A plastic housing may be used as the casing 10, and as the plastic housing has a higher resilience coefficient, the tactile sense when the finger or palm performs a press and touch operation is enhanced, and thus the user's experience is improved. It shall be noted that in this embodiment, the plastic housing used as the casing 10 is just an example for explanation, in actual application, the casing 10 may also employ a glass housing, or other insulating materials for fabrication. The material and type of the casing 10 is not specifically limited.

Furthermore, the touch area 111 has a concave or convex annular structure at its periphery, as shown in FIG. 2 and FIG. 3. As shown in FIG. 2, the touch area 111 may have an annular protrusion structure; or, as shown in the FIG. 3, it may have an annular groove structure. Thus, by means of the annular groove structure and the annular protrusion structure formed on the outer surface of the casing 10, the accuracy for the user's finger pressing or touching the touch area 111 on the outer surface of the casing 10 is increased, and thus the user's experience is improved.

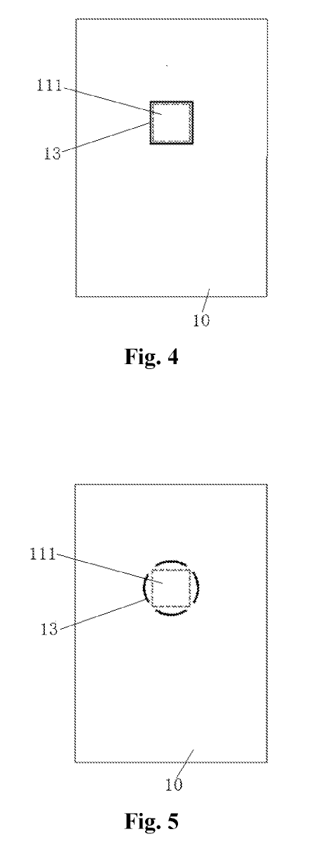

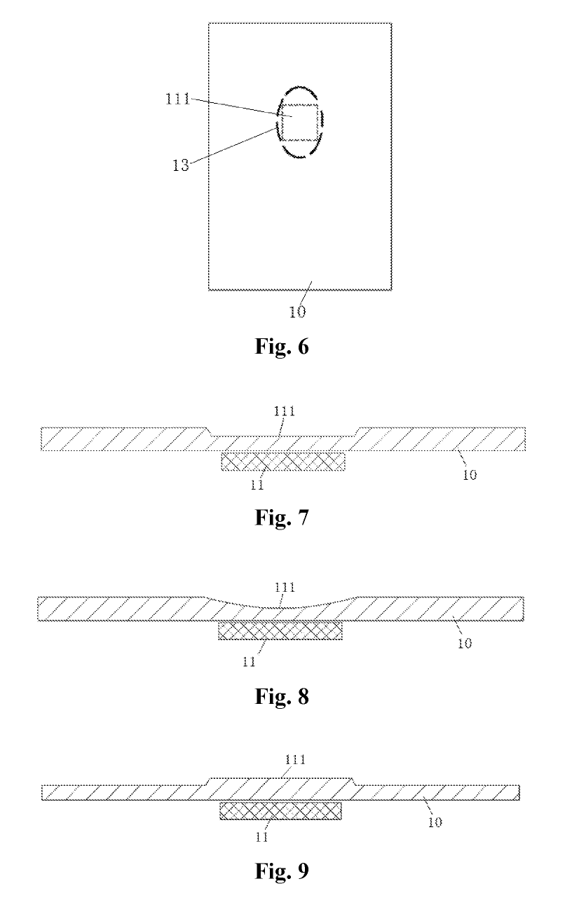

Moreover, to satisfy with the user's use requirements, the annular structure 13 is a continuous annular structure as shown in the FIG. 4. Alternatively, the annular structure 13 is an annular structure with a plurality of breakpoints, as shown in the FIG. 5 and FIG. 6. Moreover, to satisfy with design requirements of different mobile terminals, as shown in the FIG. 4 to FIG. 6, the annular structure 13 may be a square structure, a circular structure or an oval structure. Therefore, when the user presses or touches the touch area 111 located on the outer surface of the casing 10, the annular structure 13 on the casing 10 may be find out directly by finger touching, and the user can thus be aware of the location of the touch area 111 on the casing 10, so that a quick operation to the sensing identification module 11 is achieved.

It shall be noted that in this embodiment, the annular structure 13 is described as a square structure, a circular structure or an oval structure just for illustration, and in actual implementation, the annular structure 13 may also have other shapes according to actual use requirements, thus the shape of the annular structure 13 in this embodiment is not limited thereto. In addition, in this embodiment, the touch area 111 is described as being located at the bottom of the casing 10 just for illustration, i.e. the sensing identification module 11 is described as being arranged at an inner surface corresponding to the bottom of the casing 10 just for illustration, in actual implementation, the sensing identification module 11 may also be located at a front cover or a sidewall of the casing 10, i.e. the sensing identification module 11 may also be arranged at the inner surface corresponding to the front cover or the sidewall of the casing 10, so that the mobile terminal may also realize sensing identification to the user's fingers or palm from a front or aside of the casing, to meet various operation habits of different users.

The second embodiment of the present patent application relates to a mobile terminal and is roughly the same as the first embodiment. The key distinction between the first and second embodiment is that in the second embodiment, the touch area 111 on the casing 10 as a whole is a concavity (namely, a first concavity); the concavity facilitates the user to find out the touch area 111 located on the outer surface of the casing 10 as to realize a quick operation to the sensing identification module 11. Besides, since the touch area 111 is a concavity, it is possible to increase the accuracy of the user's finger pressing or touching the touch area 111 on the outer surface of the casing 10, and thus the user's experience is improved.

Moreover, in order to satisfy with the use habits of different users, the concavity is a concave plane, as shown in the FIG. 7. Alternatively, the concavity is a concave arc surface, as shown in the FIG. 8, so as to satisfy with the use requirements of different users.

In details, when the casing 10 is fabricated, a groove may be formed at a part of the outer surface of the casing 10, which correspond to the sensing identification module 11, so that a grove fitting with the user's finger may be formed on the outer surface of the casing 10. It shall be noted that, in order to ensure that a height difference between the touch area 111 and the outer surface of the casing 10 is not too much to affect the appearance of the whole casing 10, a depth of the groove should be controlled, and the height difference between the outer surface of the casing 10 and a bottom of the groove in a range of 0.1 mm to 1 mm is desired.

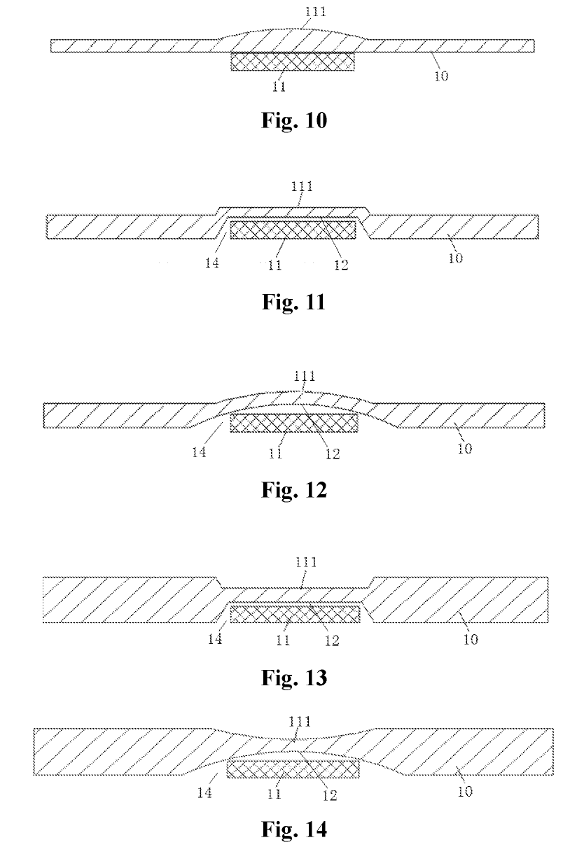

In addition, in an alternative embodiment, the touch area 111 on the casing 10 as a whole is a convexity. In details, the convexity is a convex plane as shown in FIG. 9; or be a convex arc surface as shown in FIG. 10. From the contents mentioned above, it is easy to find out that the touch area 111 of this embodiment may employs a concave structure, or a convex structure, thus both design requirements of different products and the use requirements of different users could be satisfied.

The third embodiment of the present application relates to a mobile terminal, which has a further improvement on the basis of the second embodiment. The main improvement lies in that in this embodiment, as shown in FIG. 11, an inner side of the casing 10 corresponding to the touch area 111 includes a concavity (namely, a second concavity), and the sensing identification module is arranged within the second concavity.

From the contents mentioned above, it is easy to find out that the casing thickness of the area where the sensing identification module 11 is located is effectively reduced by fabricating the portion of the casing 10 fitted with the sensing identification module 11 as the second concavity 12, and thus the signal strength between the touch area 111 and the sensing identification module 11 when the user is pressing or touching the touch area 111 is further strengthened; moreover, data collection of the sensing identification module 11 is facilitated, and thus the user's experience is improved.

Furthermore, in order to satisfy with the use habits of different users, the second concavity 12 may be a concave plane as shown in the FIG. 11, or be a concave arc surface as shown in the FIG. 12, so as to satisfy with actual requirements for assembly and design of different devices. However, it shall be noted that when the second concavity 12 is a concave plane, the sensing identification module 11 may be directly fitted on the concave plane, so as to further reduce the distance between the sensing identification module 11 and the touch area 111, and further strengthen the signal strength between the touch area 111 and the sensing identification module 11 when the touch area 111 is pressed or touched.

Specifically, when the casing 10 is fabricated, a groove may be formed at a part of casing 10 with which the sensing identification module 11 needs to be fitted, so that a groove 14 capable of accommodating the sensing identification module 11 is provided at the inner surface of the casing 10. It shall be noted that in order not to have much affection on the strength of the casing 10 while strengthening the signal strength between the touch area 111 and the sensing identification module 11 after the touch area 11 is pressed, a depth of the groove 14 should be controlled when forming the groove 14 in the inner surface of the casing 10, so that the casing 10 has enough strength after the touch area 111 is pressed by the user, so that a deformation in the casing 10 is avoid.

In addition, in order to strengthen the signal strength between the touch area 111 and the sensing identification module 11 after the touch area 11 is pressed, to a maximum degree, in this embodiment, the touch area 111 may employ the structure mentioned in the second embodiment, as shown in the FIGS. 13 to 14. Specifically, the touch area 111 on the casing 10 as a whole is a convexity, so that the thickness of the casing 10 at this portion is reduced, and the distance between the sensing identification module 11 and the touch area 111 is further reduced; thus the signal strength between the touch area 111 and the sensing identification module 11 when the touch area 111 is pressed or touched, is further strengthened, which makes the response of the whole operation faster and more convenient.

Those skilled in the art may understand that the embodiments mentioned above are detailed embodiments for implementing the present patent application, and in actual implementation, various changes may be made to the format and the details of the application which still fall within the spirit and scope of the present application.

What is claimed is:

1. A mobile terminal comprising a sensing identification module, wherein the sensing identification module is arranged within a casing of the mobile terminal, an area of an outer surface of the casing corresponding to the sensing identification module serves as a touch area, and at least part of the touch area is concave or convex.

2. The mobile terminal according to claim 1, wherein the touch area comprises a first concavity formed at the outer surface of the casing, or the touch area comprises a convexity formed at the outer surface of the casing.

3. The mobile terminal according to claim 2, wherein the first concavity comprises a concave plane or a concave arc surface.

4. The mobile terminal according to claim 2, wherein the convexity comprises a convex plane or a convex arc surface.

5. The mobile terminal according to claim 1, wherein the touch area has an annular structure at a periphery thereof and the annular structure comprises an annular protrusion structure.

6. The mobile terminal according to claim 1, wherein the touch area has an annular structure at a periphery thereof, and the annular structure comprises an annular groove structure.

7. The mobile terminal according to claim 5, wherein the annular structure comprises a continuous annular structure.

8. The mobile terminal according to claim 5, wherein the annular structure comprises an annular structure with breakpoint.

9. The mobile terminal according to claim 1, wherein the touch area further comprises a second concavity formed at an inner side of the casing, and the sensing identification module is arranged within the second concavity.

10. The mobile terminal according to claim 9, wherein the second concavity comprises a concave plane or a concave arc surface.

11. The mobile terminal according to claim 1, wherein the touch area is located at a bottom, a front or a side of the casing.

12. The mobile terminal according to claim 1, wherein the casing comprises a plastic housing.

13. The mobile terminal according to claim 1, wherein the casing comprises a glass housing.

14. The mobile terminal according to claim 1, wherein the sensing identification module comprises a fingerprint identification module configured to detect a fingerprint of a user's finger, and the touch area serves as a sensing projection area for projecting fingerprint information of a user to the sensing identification module when the user touches or presses the touch area by a finger.

15. The mobile terminal according to claim 1, wherein the touch area comprises a groove formed at the outer surface of the casing and corresponds to the sensing identification module, and a height difference between the outer surface of the casing and a bottom of the groove is 0.1 mm to 1 mm.

16. An apparatus, comprising:
a casing; and
a sensing identification module arranged in the casing;
wherein an outer surface of the casing corresponding to the sensing identification module is configured as a touch area, and a thickness of at least part of the touch area is different from a main body of the casing.

17. The apparatus according to claim 16, wherein the touch area comprises a first concavity formed at the outer surface of the casing, and the thickness of the touch area is less than the main body of the casing.

18. The apparatus according to claim 16, wherein the touch area comprises a convexity formed at the outer surface of the casing, and the thickness of the touch area is greater than the main body of the casing.

19. The apparatus according to claim 16, wherein the touch area further comprises a second concavity formed at an inner surface of the casing, and the sensing identification module is received in the second concavity.

20. The apparatus according to claim 16, wherein the sensing identification module is a fingerprint identification module configured to detect a finger print of a user's finger, and the touch area serves as a sensing projection area for projecting fingerprint information of a user to the sensing identification module when the user touches or presses the touch area by a finger.
